(19) United States
(12) Patent Application Publication
(10) Pub. No.: US 2007/0102427 A1
(43) Pub. Date: May 10, 2007

(54) Microwave temperature control with conductively coated thermoplastic particles

(76) Inventor: James C. Young, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/509,224

(22) Filed: Aug. 24, 2006

Related U.S. Application Data
(60) Provisional application No. 60/712,130, filed on Aug. 29, 2005.
(60) Provisional application No. 60/712,073, filed on Aug. 29, 2005.
(60) Provisional application No. 60/712,222, filed on Aug. 29, 2005.

(51) Int. Cl. H05B 6/64

(52) U.S. Cl. 219/759

(57) ABSTRACT

Microwave susceptors comprising conductively coated polymeric particles permit heating while avoiding overheating. Provided is a composition comprising a binder, a plurality of microwave-interactive particles dispersed therein; and a plurality of particles dispersed therein that have a microwave-interactive coating, said coating comprising a microwave interactive coating material capable of converting microwave energy to heat, wherein the coating is disposed upon or embedded within the surface of such particle.

This application claims the benefit of U.S. Provisional Applications 60/712,130, 60/712,073 and 60/712,222; each of which was filed 29 Aug. 2005, and is incorporated in its entirety as a part hereof for all purposes.

### TECHNICAL FIELD

The present invention relates to the field of microwave heating, and in particular to the use of so-called microwave susceptors for providing localized thermal heating. Most particularly, the present invention relates to a technology for providing thermal heating while avoiding overheating. The inventions provided herein are useful, for example, for the purpose of browning or crisping a human food item.

### BACKGROUND

A microwave susceptor, as used in both consumer and industrial applications, is a material that absorbs microwave energy, converts the absorbed energy to heat energy, and thereby heats surrounding media. As typically used, a microwave susceptor may be formed as a thin film where a layer of a dielectric film, typically made from poly(ethylene terephthalate) (“PET”), is aluminized. Often this aluminized film is laminated to other layers of plastic film or cellulosic paper, thereby forming a multilayer laminate structure. When it is desired to use a microwave susceptor to heat a food item, the food item is typically disposed in heatable proximity to the susceptor such that, upon microwave irradiation, the food item will be heated by both direct absorption of microwave radiation and by conduction and/or convection heating from the susceptor. Microwave susceptors are often employed when it is desired to impart a browned and/or crisped surface to a food item during microwave heating.

Particulate susceptors are described in EP 466,361, which discloses a polymeric matrix containing both microwave-interactive particles and so-called blocking particles which are not microwave-interactive. The microwave-interactive particles are particles or flakes prepared from metals and conductive non-metals. The particles are combined in a polymeric matrix that may be coated onto a substrate. Ink-based coatings are disclosed.

The use of non-conductive or semi-conductive particles of various sorts to moderate the heating effect of metallic particles mixed therewith in a susceptor is disclosed, for example, in U.S. Pat. Nos. 4,864,089; 4,876,423; 5,175,031; and 5,285,040.

Conductively coated polymeric particles are also described in EP 397,321, which discloses dielectric particles coated with microwave-interactive coatings. The coated dielectric particles may be imbedded in a polymeric matrix, or directly coated onto a substrate. Included are glass and ceramic particles, and meltable particles such as hot melt adhesive polymeric particles. Disclosed is a process for forming an adhesive bond involving heating conductively coated hot melt adhesive particles to a temperature at which they coalesce to form a continuous adhesive layer. Methods disclosed therein for preventing overheating in microwave heating applications include the use of oxidizable coatings, and coatings which exhibit increasing conductivity with increasing temperature. The binder polymer may be a cross-linked silicone rubber or epoxy.

Current technology is limited in the degree of browning and crisping of human food items that can be achieved by the temperature limitations of the microwave oven systems in common commercial use. It is desired to expand the range of browning and crisping capabilities of microwave susceptors by developing microwave susceptors that are capable of operating at higher temperatures. Many putative solutions to the problem exhibit a tendency to impart excessive heat to a food item, resulting in charring, or even burning, rather than browning. In some instances, an entire microwaveable package will ignite. The technological challenge is not simply to provide a higher temperature exposure to the food item, but to control the temperature so that the food item will properly brown and crisp without charring.

In addition, the metallized films in common commercial use are not well suited to patterning to provide selective heating. Efforts have been underway for many years to develop new microwave susceptor materials that could be positioned on a package with the accuracy of printing.

### SUMMARY

In one embodiment, this invention provides a composition that includes (a) a binder; and (b) dispersed within the binder, (i) a plurality of first particles that comprise a body material that is microwave-interactive; and (ii) a plurality of second particles that comprise (A) a body material that is not microwave-interactive, and (B) a coating formed from a coating material that is microwave-interactive, wherein the coating material is disposed upon, or embedded within, the surface of the body of the second particles.

The above described composition may be formulated as an ink that may be deposited on a surface, may be fabricated as a film, may be deposited on a substrate, or may be fabricated as a microwave susceptor. Other embodiments of this invention thus provide such an ink, film, substrate or susceptor, any or all of which may be used as, or incorporated into, packing that is permitted for use in conjunction with human food, such as packaging that protects human food from contamination.

In another embodiment, this invention provides a microwave susceptor that includes a substrate that includes a material that is permitted for use in conjunction with human food, wherein the above described composition is deposited on the substrate.

In a further embodiment, this invention provides a microwave susceptor that includes a film fabricated from the above described composition.

In yet another embodiment, this invention provides a method of making a microwave susceptor comprising fabricating the susceptor from the above described composition. The susceptor may be fabricated as a film, or as a substrate on which the composition is deposited.

In yet another embodiment, this invention provides a method of heating an object by placing the object is heatable proximity to a microwave susceptor that includes a composition as described above, and subjecting the object and the microwave susceptor to microwave radiation.

### BRIEF DESCRIPTION OF THE DRAWINGS

FIG. 1 is a schematic representation of the microwave temperature measurement apparatus employed in the examples.

FIG. 2 shows the results of microwave heating experiments in Examples 1-3 and Comparative Example 1.

FIG. 3 shows the results of microwave heating experiments in Examples 4-6.

FIG. 4 is a photograph of the results of the pizza browning experiments of Examples 7-9 and Comparative Example 2.

FIG. 5 is a photograph of the pizza browning experiments of Examples 10-12.

### DETAILED DESCRIPTION

According to this invention, a composition is prepared that includes a plurality of particles that are prepared from a body material that is not microwave-interactive, and from a coating material that is microwave-interactive. The body material of a particle is the material from which a particle is formed in the sense of the body that is defined by all, or substantially all, of the mass and volume of the particle. The coating material of a particle is the material from which a coating for the particle is formed where the coating is disposed upon, or embedded within, the surface of the particle body that is formed from the body material. Thus one of the particles as used in a composition of this invention exists in the form of a particle having a body material that is not microwave-interactive, and a coating formed from a coating material that is microwave-interactive, wherein the coating material is disposed upon, or embedded within, the surface of the body of the non-microwave-interactive particle.

A material is microwave-interactive when it is electrically conductive, and/or when it experiences heating when subjected to microwave irradiation. Metal is a commonly-employed microwave interactive material. It is known, for example, that surface currents are induced in metallic surfaces upon exposure to microwave radiation with concomitant production of electrical resistive heating. Correspondingly, a material is not microwave-interactive when it is not electrically conductive, and/or when it does not experience heating when subjected to microwave irradiation.

In one embodiment, the non-microwave-interactive body material from which a coated particle is prepared may be a thermoplastic polymer. Thermoplastic polymeric particles suitable for use as the body of a coated particle may be fabricated from any thermoplastic polymer that is transparent to microwave radiation, maintains its thermo-mechanical integrity up to the intended use temperature, and is compatible with the selected coating and the binder within which it will be dispersed. Some methods of using the composition of this invention will require mechanical integrity at a higher temperature than others. For example, in microwave cooking, heating a stew does not require as high a temperature as cooking and browning raw pizza dough. A film susceptor based upon oriented PET film, for example, exhibits the required thermo-mechanical integrity for heating a stew, but is only marginally useful for browning raw pizza dough. Similar considerations will apply to the selection of a thermoplastic polymer from which to prepare a coated particle.

Thermoplastic polymers suitable for use as the body material of a coated particle should thus be thermally stable up to a selected temperature representative of the anticipated use. For example, they should be thermally deformable, but not subject to significant melt flow, under the essentially zero-shear conditions encountered in microwave heating, such as in cooking, which is a typical use for a susceptor prepared from the composition of this invention. Thermoplastic polymeric particles suitable for use as the body of a coated particle include those having zero-shear viscosity sufficiently high that melting in situ upon being subject to microwave heating does not result in a significant degree of coalescence as a result of polymer flow under the nearly zero-shear conditions as typically seen in a microwave oven, such as during food preparation.

Thermoplastic polymers suitable for such purpose include polyesters [particularly PET and poly(ethylene naphthalate) (“PEN”)], polycarbonates, polyethersulfones, polyarylsulfones, polyamides, polyetherketones [particularly polyetheretherketone (“PEEK”)], polyacrylates [particularly polymethylmethacrylate (“PMMA”)], as well as polyolefins such as polyethylene (“PE”) and polypropylene (“PP”). Preferred are PET, PE and PP, derivatives thereof, and mixtures of any of same. A wide range of thermoplastic polymeric particles suitable for use as the body of a coated particle in the composition of this invention are available from commercial sources such as Goodfellow Corp, Devon, Pa.

Coating materials suitable for preparing a coated particle, such as a coated thermoplastic particle, include electrically conductive and semi-conductive materials such as metals, metal-containing compounds and carbon black. The thickness of a suitable coating ranges from about 0.05 to about 5 micrometers, and is preferably in the range of from about 0.1 to about 1 micrometer. Preferred coating materials include carbon black, graphite, copper, nickel or zinc, as well as materials such as carbon-coated iron or carbon-coated aluminum having a thickness in the range of from about a few nanometers to about a few micrometers. Mixtures of two or more of such coating materials, or respective coated particles, are also satisfactory.

The coated particles suitable for use in the present invention may be prepared by any convenient process such as electroless plating, dry-particle imbedding, sputtering and vapor deposition. Water-based metal plating processes (including electroplating, electroless plating and others) can be used to fabricate metal coated particles. The Metal Coated Particles division of Federal Technology Group (Bozeman, Montana) provides a wide variety of metal-coated polymeric particles suitable for use herein. The coating can be made from a single metal, or may be prepared from mixtures of layers of different metals.

Coated particles suitable for use in this invention, particularly in those embodiments employing non-metallic coatings, may be prepared using the so-called dry embedding process. The dry-particle embedding process may be satisfactorily performed employing a Hybridization System manufactured by NARA Machinery Company (Tokyo, Japan). In that process, a finer coating powder and a larger core powder are first intimately mixed and dispersed into a gaseous medium to form an “ordered mixture”. A suitable core powder is characterized by an average equivalent spherical diameter of about 1 to about 100 micrometers, preferably about 20 to about 40 micrometers. A suitable coating powder is characterized by average equivalent spherical diameter of about 1 to about 1000 nanometers, preferably about 100 to about 1000 nanometers, but in no event greater than about 10% of that of the core powder. Conductive materials that have been found suitable for use as the coating powder include conductive carbon black materials and conductive graphite materials, and mixtures of either or both.

After the powders are dispersed and mixed, they are subjected to mechanical and thermal energy to form an energetic aerosol thereby causing the finer powder particles to become embedded in the surfaces of the larger particles as a result of energetic particle collisions. Treatment times of 1-5 minutes have been found to be satisfactory for this purpose. The coated product is then recovered in a collector. The weight of the coating material can range from about 5 to about 80 wt % of the total weight of the coated particle, but is preferably about 5 to about 20 wt %. In the case of a carbon coating, for example, carbon typically makes up about 5 to about 10 wt % of the total weight of the coated particle.

Also included in a composition of this invention is a plurality of particles that are prepared from a body material that is microwave-interactive. In a preferred embodiment, the body material from which this particle is prepared is a carbon material although a metal material or a metal-containing compound may be used if desired. Suitable carbon materials encompass both carbon blacks and graphite. Preferred are carbon blacks.

Particles of either kind as described above, i.e. those prepared from a body material that is microwave-interactive and those prepared from a body material that is not microwave-interactive, may be spherical in shape, but may also have other shapes such as spheroidal, ellipsoidal, granular, acicular or flaked, or other irregular, non-uniform shapes. Particles with an especially high aspect ratio, however, in excess for example of about 5:1, take on the properties of fibrils, and are less preferred. A spherical shape is preferred.

In one embodiment, the ratio of the size of the particles prepared from a body material that is not microwave-interactive to the size of the particles prepared from a body material that is microwave-interactive is in the range of about 1000/1 to about 10/1, although in other alternative embodiments such ratio may be in the range of about 500/1 to about 10/1 or in the range of about 100/1 to about 10/1. In a further embodiment, the particles prepared from a body material that is not microwave-interactive are micro-scale in size, and/or the particles prepared from a body material that is microwave-interactive are nano-scale in size.

Size of particles may be determined by average equivalent spherical diameter or by other suitable means. The term “micro-scale” as used herein concerning particle size refers to particles characterized by an average equivalent spherical diameter of greater than 1 to about 100 micrometers, preferably from about 20 to about 40 micrometers. The term “nano-scale” as used herein concerning particle size refers correspondingly to particles characterized by an average equivalent spherical diameter of about 1 to about 1000 nanometers.

The term “average equivalent spherical diameter” refers to a volume-sensitive method for determining a particle size distribution in which the volume distribution of particles is determined and the diameter of spheres exhibiting an equivalent volume distribution is computed. The average equivalent spherical diameter is then the average diameter of the population of spheres having the same volume distribution. Average equivalent spherical diameter is the principal characteristic of the particle size distribution, and such determination does not take into consideration other aspects of particle morphology such as aspect ratio, aspects of particle size distribution such as the width of the distribution, or any deviations from a gaussian distribution. For example, particle populations having particularly numerous large particles are less preferred.

Average equivalent spherical diameter, which is used to specify the average (median) size of a non-spherical particle in terms of the diameter of a sphere of the same material that would have the same mass as the particle in question, may also be calculated based on the sedimentation rate of the particle in questions as defined by Stokes' Law, Micromeritics SediGraph 5100 Particle Size Analysis System Operator's Manual, V2.03, 1990. Specific surface area refers to the area of the surface of a particle per unit weight based on the quantity of nitrogen gas that absorbs as a single layer of gas molecules on the particle. Once the gas adsorption properties of the material in question have been measured, then the surface area of the material in question is calculated using the Brunauer-Emmett-Teller equation, Micromentics Flowsorb II 2300 Instruction Manual, 1986. Equivalent spherical diameter of particles may also be measured by automated sedimentation equipment such as the Micromeritic SediGraph 5000 E particle size analyzer. This device uses low energy X-rays to determine the concentration of particles at various depths in a column of known fluid. The laws of hydrodynamics require that the settling rate of a particle in a fluid is related to the mass of the particle. The SediGraph determines the population of particles of a particular mass in the powder grade by measuring the density of particles at given levels within the fluid. Since the diameter of an ideal spherical particle is related to its mass by means of its density and volume (i.e. diameter), each density measurement in the SediGraph corresponds to a population count of particles with a mass that is equivalent to that of a spherical particle having a diameter, d (designated ESD). Therefore, particles are completely characterized by the population size distribution measured by the sedimentation technique and the average ESD corresponding to the median value in that distribution.

Alternatively, the term “micro-scale” may refer to the size of a particle in which the longest dimension of the largest cross section of the particle is in the range of greater than 1 to about 100 micrometers; and, correspondingly, “nano-scale” may alternatively be defined with respect to the same longest cross-sectional dimension where that is in the range of about 1 to about 1000 nanometers.

Also included in a composition of this invention is a binder such as a matrix material. In one embodiment, the material from which the binder is prepared is not microwave-interactive, and may be a polymeric material. Both kinds of particles as described above are dispersed in the binder to form a composition of this invention. In a further preferred embodiment, the particles prepared from a body material that is microwave-interactive are dispersed in the binder within and/or among the particles prepared from a body material that is not microwave-interactive.

The composition of this invention may formulated to be sprayable or printable, such as an ink, and a suitable binder is thus an ink binder such as a fluid organic and resinous printing ink vehicle or film former that serves as a base or matrix to hold the ink together and to the underlying substrate. The vehicle can comprise any suitable ink vehicle such as an acrylic, protein, shellac, or maleic resin. The solvent can be water or a variety of any known, so-called spirit based ink vehicles. Water based inks are preferred.

In an alternative embodiment, the binder may be prepared from a natural polymer, which is a polymeric material that occurs in nature, and is preferably obtained from a plant source. A natural polymer suitable for use as the binder in a composition of this invention is preferably water-soluble, and is more preferably a material having FDA or equivalent governmental clearance for contact with human food. Suitable natural polymers for use as binders include proteins or derivatives thereof; corn starch; polysaccharides or derivatives thereof; and cellulosic materials. Preferred natural polymer binders are commercially available, water-soluble, can be used as a food additive, and are thermally stable up to about 200° C. in air. The most preferred binder is a soy protein or a derivative thereof.

The mixture as described above of two different kinds of particles and a binder, from which a composition of this invention is prepared, may be subjected to any of the various particle comminution methods known in the art, including without limitation roll-milling, ball-milling, high-shear air milling and ultrasonication, in order to separate any aggregated particles, and disperse the particles in the binder. This will form a mixture of substantially non-aggregated particles in the binder, which may take the form of a dry or liquid (aqueous or non-aqueous) composition. The term “substantially non-aggregated” shall be understood to mean that the particulate material is as free as possible of particle aggregates. In any real population of particles, there will likely always be some aggregates. While in principle the presence of aggregates of particles does not render the invention inoperable, it is highly preferred that steps be taken to break up aggregates and prevent them from forming.

In a composition of this invention, the particles prepared from a body material that is not microwave-interactive and the binder are present in respective amounts such that the concentration of the particles prepared from a body material that is not microwave-interactive is about 5 to about 50% by weight, and is preferably about 10 to about 30% by weight, of the total combined weight of those two components. The particles prepared from a body material that is microwave-interactive are present in the composition in amount such that their concentration is about 10 percent or less, and preferably about 1 percent or less, of the weight of the particles prepared from a body material that is not microwave-interactive.

In a preferred embodiment, a suitable ink concentrate may be formed by combining about 5 to about 20 parts by weight natural polymer binder, about 7 to about 20 parts by weight of substantially non-aggregated particles prepared from a body material that is microwave-interactive, about 50 to about 88 parts by weight of water, and, optionally, up to 10 parts by weight of a chemical dispersing aid for the particles, wherein the binder, particles, solvent and chemical dispersing aid total 100 parts by weight. Coated particles prepared from a body material that is not microwave-interactive are then added to this concentrate.

When a composition hereof is formulated as a ink, it may contain a protein polymer or an acrylic latex, such as are known in the art of printing to be suitable as binders in ink compositions. Such an ink composition or others may be applied by depositing the ink composition onto a surface such as a substrate. Suitable methods for depositing the ink include screen printing, gravure coating and draw-down bar coating. To obtain good thickness uniformity in depositing an ink, a critical quality in the field of microwave cooking, it is desirable to deposit the ink in several thin layers to the desired thickness rather than in one layer.

A shaped article may be fabricated from the composition of this invention. In forming the shaped article, however, it is desirable to avoid heating the composition to the point at which the non microwave-interactive body material will undergo deformation. A shaped article may take the form of a free-standing film or sheet that is formed itself from the composition; a substrate on which it the composition of this invention is deposited, often in the form of a pattern; or a layered structure or a multi-layered laminate that is formed from and/or incorporates the free-standing film or sheet, or the substrate with deposit, in addition to other layers.

Suitable methods for forming a shaped article include film casting, molding, profile extrusion, pultrusion and the like. Lamination of layers may be performed by any convenient means such as thermal calendaring or adhesive bonding. The shaped article may also be prepared, however, simply by depositing the composition of this invention onto a substrate by printing or coating an ink, as described above. The substrate selected for such purpose may be material suitable to serve as a free-standing microwave susceptor, or it may be material suitable for forming or enclosing a package. The printing may be performed either uniformly, or in a specific pattern to deliver the heat where heating is desired. The shaped article, formed as described above as a film, layered structure or printed substrate, may then be further fabricated into any commercially useful article, such as a microwave susceptor, or a package to enclose a microwave susceptor and an object to be heated, such as a food item.

A material suitable for use as a layer in a layered structure, or as a substrate to receive a deposited composition, may be a dielectric material that is not microwave interactive. Suitable materials include thermoplastic or cross-linked polymeric films or sheets, including polyesters, such as PET, PEN and copolymers thereof with various polyester monomers, and films of polyetheretherketone. A substrate onto which a composition hereof is deposited may also be fibrous, such as paper, including cellulosic paper or a paper of the Kevlar® or Nomex® brands of polyaramid fibers available from DuPont. A printed substrate will typically be about 25 to about 50 micrometers thick, and the composition will be deposited in a thickness on the substrate of about 20 to about 40 micrometers. Substrate materials are preferably stable up to about 2500°-300° C. The maximum or plateau temperature of a desirable substrate material will generally increase with increasing concentrations in the deposited composition of the conductively coated particles.

An object to be heated may be disposed in heatable proximity to a microwave susceptor fabricated as a shaped article from a composition of this invention. Upon being subjected to microwave irradiation, the microwave susceptor will undergo heating, which in turn will cause the heatable object to undergo heating, particularly at the surface thereof. The heatable object may be any non-electrically conductive material, which may or may not be transparent to microwave radiation. Thus, a heatable object may be heated both by the direct absorption of microwave radiation, and by the conductive heating of the microwave susceptor.

A further embodiment of this invention is thus a method of heating an object by placing the object in heatable proximity to a microwave susceptor fabricated as a shaped article from the composition of this invention, and exposing the object and the susceptor to microwave radiation. In a preferred embodiment, the object to be heated is a food item such as a pizza.

Of particular interest is the use of the composition of this invention to heat a food item placed in proximity to a susceptor that has been fabricated by the deposition on a substrate of the composition. The food item may be placed directly in contact with the substrate, or may be placed in a separate container which is placed in contact with the susceptor. A food item of particular interest is a pizza, which requires excellent browning and crisping without charring. The food item, and a susceptor prepared from a composition hereof, may be contained in a housing, enclosure or package for ease of storage, shipping and protection from contamination. Thus, according to a method of the invention, the combination of a food item disposed proximate to a susceptor as provided herein may be placed in a package for the purpose of being heated. The package may be provided with an opening to the interior during heating in order to allow venting of hot gases.

A further embodiment of this invention is thus a combination of an object and a microwave susceptor wherein the microwave susceptor is fabricated from the composition of this invention, and wherein the object is placed in heatable proximity to the susceptor. In a preferred embodiment, the object to be heated is a food item such as a pizza.

In other embodiments, a microwave susceptor may be fabricated from a substrate made from a material that is permitted for use in conjunction with human food, such as a material having FDA or equivalent governmental clearance for use in conjunction with or contact with human food, wherein the composition of this invention is deposited on the substrate. The substrate may be a material that is not microwave-interactive, such as a dielectric material, and may be a material selected from the group consisting of thermoplastic or cross-linked polymeric films or sheets, cellulosic papers, and polyaramid papers. Further the substrate may be a layer in a layered structure, and the layered structure may be used to protect human food from contamination. The human food that is protected may be a food item such as a frozen pizza. Such a susceptor may also be enclosed in or contacted with a package that protects human food from contamination.

In other embodiments, a microwave susceptor may be a film fabricated from the composition of this invention, and such film may be laminated to a substrate or incorporated into a layered structure. The substrate may be prepared from materials such as described above. The layered structure may be used to protect human food, such as a frozen pizza, from contamination.

In a further embodiment, this invention also provides a method of making a microwave susceptor by fabricating the susceptor from a composition of this invention. The composition may be fabricated as a film, and the method may further involve incorporating the film into a layered structure. The layered structure may in turn be fabricated from material that is not microwave interactive, and the layered structure may be fabricated into a package that protects human food from contamination.

In making a susceptor, the composition hereof may be deposited on a substrate, and the substrate may be enclosed in, or contacted with, a package that protects human food from contamination. The package may be fabricated from a material that is not microwave interactive.

In a further embodiment, this invention also provides method of heating an object by placing the object is heatable proximity to a microwave susceptor that includes a composition as described above, and coated with carbon black fine particles (Cabot Monarch 4750) using the dry embedding method employed in the hybridization system made by NARA Machinery Co. The amount of carbon black coating was 10% by weight of the weight of the coated polymeric particles. The hybridizer was run at 1000 RPM for 10 minutes.

A carbon black ink concentrate was prepared in three steps. First, a carbon black concentrate was prepared as follows: Surfactant, water and defoamer were mixed together with a Cowles blade at 1800 rpm for 10 minutes at room temperature. Carbon black pearls were added all at once while under agitation and allowed to mix for 30 minutes. The mixture was then milled in 2 passes through a sand mill.

A portion of the ink concentrate and water were mixed in a one liter vessel with a Cowles blade at 500 rpm for 10 minutes at room temperature. Soy protein was then added to the thus formed carbon black dispersion, and the pH of the resulting mixture was adjusted to 10 by adding ammonium hydroxide. This pH-adjusted mixture was mixed with the Cowles blade at 1500 rpm for one hour. The speed was then reduced to 500 rpm and glycerin and biocide were added and mixed for 10 minutes. The components of the intermediate ink were:

carbon black: 12.5 wt % (Cabot Black Pearls 4350),

dispersing aid: 5.0 wt % (Tween 80),

soy protein: 12.5 wt % (DuPont Procote 5000 binder),

NH₃: 2.1 wt %, subjecting the object and the microwave susceptor to microwave radiation.

Upon exposure to microwave radiation, a food item disposed proximate to a susceptor as provided herein is heated. The food item absorbs microwave energy directly, and is further subject to conductive and/or convective heating from that is prepared from microwave-interactive materials. The food item is heated with steadily increasing temperature to a pre-determined temperature at which it is believed the particles that are prepared from a body material that is not microwave-interactive begin to deform. The temperature at which these particles begin to deform is determined by the melting point or glass transition temperature of the body material from which the body of those particles is prepared, which is thus typically a thermoplastic polymer.

Without wishing to be bound by any theory, it appears that the deformation of the particles prepared from a body material that is not microwave-interactive reduces the effective heating rate of the susceptor, the temperature of the susceptor achieves a plateau, and a substantially constant cooking temperature is thereafter provided as a result. Those particles thus provide efficient microwave heating to a predetermined temperature above which there is, effectively, a quenching of the heating process, and the prevention of overheating. Prevention of overheating in microwave cooking applications represents a major safety and food quality goal. By selection of the binder, the body material for each of the particles, the microwave-interactive coating, and the thickness of the coating, a wide range of controllable temperatures for specific heating applications, including a range of microwave cooking temperatures and durations, can be achieved. It is thus found that excellent results can be obtained in preparing pizza, using the composition of this invention or a shaped article prepared therefrom, with good browning and crisping but without charring. The range of circumstances for which the compositions of this invention, and shaped articles prepared therefrom, are useful is further extended by additionally preparing compositions designed particularly for microwave ovens of varying power, which may vary, for example, within at least the range of about 700-1200 Watts.

The present invention is further described in the following specific embodiments, which are illustrative but not limiting.

### EXAMPLES

### Examples 1-3 and Comparative Example 1 Carbon-Coated Polymeric Particles in Carbon-Filled Polymer Matrix

A. Preparation of Inks

Polymeric particles made of polyethylene terephthalate (PET), polypropylene (PP), and polyethylene (PE) having average diameters shown in Table 1 and purchased from Goodfellow Corporation, were

glycerin: 1.0 wt %,

defoamer: 0.5 wt % (Foamblast EPD),

biocide: 0.2 wt % (Proxel GXL), and

water: 66.2 wt %.

The pH of this ink was 10.

For each specimen, 10 grams of the thus prepared carbon-black ink composition was combined in a 100 ml glass jar with 10 grams of a 20% soy protein aqueous solution, and 10 grams of carbon-black coated polymeric particles prepared according to the dry-embed method hereinabove described. The mixture so-formed was mixed in a low shear mixer with a Cowles blade to form a final ink composition.

The final ink composition was then coated onto a 30 cm×30 cm×0.1 mm thick sheet of DuPont Type 4.0N710 aramid paper. A uniform base coat of 0.127 mm (5 mils) wet film thickness was first applied to the substrate using a #12 draw-down coating rod over a flat glass bed on which the substrate was laid. The composition of the base coat was 14.7 wt % modified soy protein (Pro-cote 200 from Bunge), 1.1 wt % glycerin, 0.74 wt % ammonia, and 83.46 wt % water. The thus coated sheets were dried in a 100° C. oven for 15 minutes. A second coating of the same ink composition was then applied using the #12 draw-down rod to the base coating in a direction 90° to that in which the base coating was applied. The twice-coated sheet was dried in a 100° C. oven for 20 minutes and then allowed to cool.

The thus prepared coated paper was cut into approximately 2″×2″ (approximately 5.1 cm×5.1 cm) square samples, and larger 16.5 cm diameter circular samples, for use as susceptors in heating and pizza cooking tests.

B. Microwave Thermal Test Method

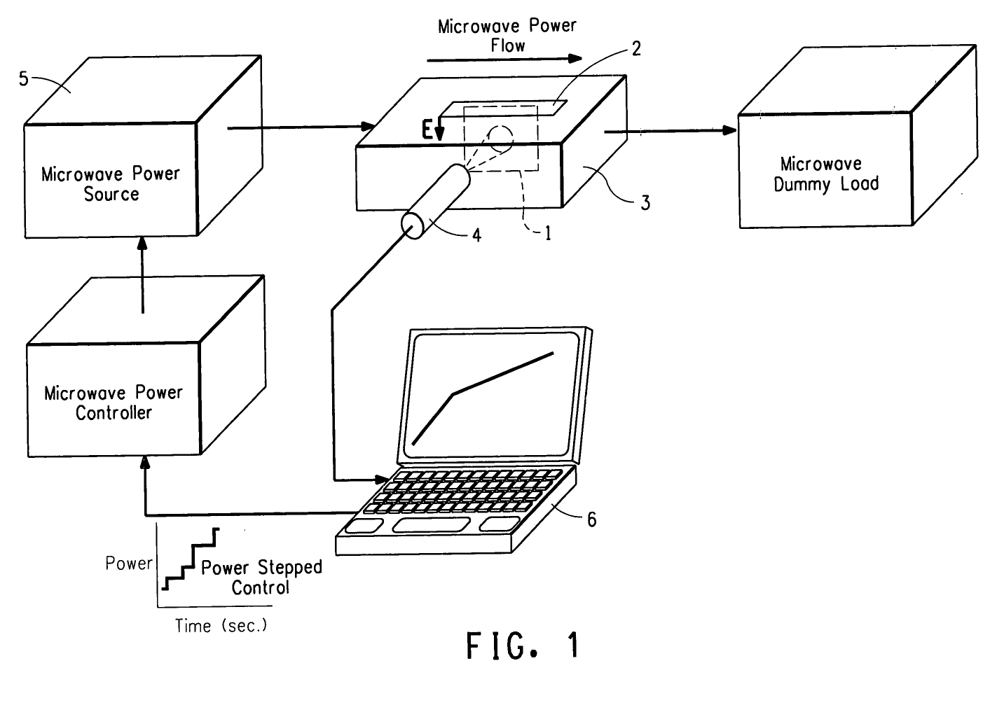

The square microwave susceptor samples, prepared as described above, were exposed to 300 Watts of microwave power at 2450 MHz in a microwave wave-guide instrumented with an Iris infrared (IR) thermometer equipped with a non-contacting infrared temperature probe. FIG. 1 shows a block diagram of the instrument.

In using the instrument shown in FIG. 1, a test sample, 1, was placed in a rectangular waveguide, 2, supporting a TE10 standing wave mode at 2450 MHz. In the TE10 mode, the vertical electric field is maximum at the middle of the long side of the cross section, 3, and the sample is positioned at this maximum. An infrared thermometer, 4, was placed on the short wall pointing at the test sample. The microwave energy source was a magnetron (Astex1500A), 5, oscillating at 2450 MHz, with continuously variable power output in the range of 50 to 1500 W. The magnetron power output was controlled by a computer, 6. Power was increased step wise at a rate of 1 W/sec. The accompanying rise in temperature of the test sample was determined by the infrared (IR) thermometer.

The IR thermometer used to measure the change in temperature of the test samples in the analytical instrument described above gave very precise readings, but the accuracy of its readings, in terms of comparing the change in temperature of one susceptor to another, can be affected by the fact that an infrared thermometer is calibrated to read the temperature of a black body. The thin, coated films used as the samples herein deviated from an ideal black body, and different types of susceptors may also differ in reflectance such that exposure to a particular dose of microwave radiation can result in different degrees of heating. The readings given by the IR thermometer were thus interpreted in view of those factors.

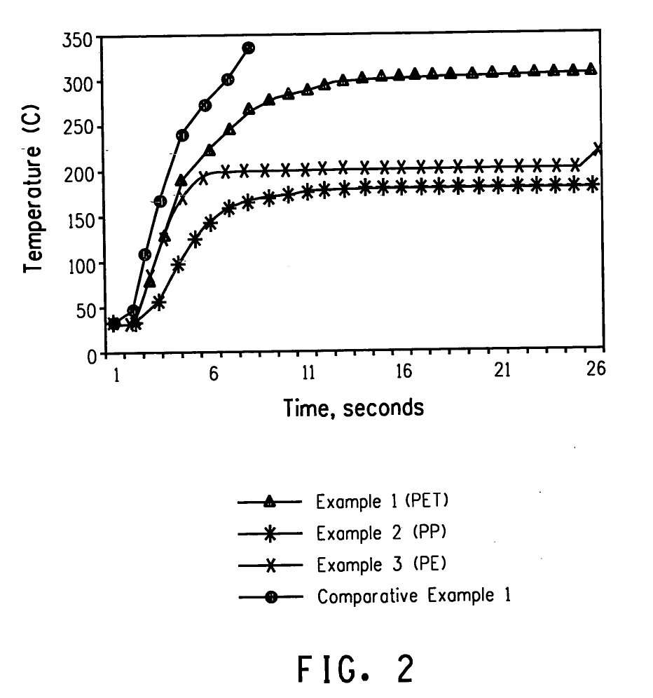

Table 1 and FIG. 2 show the microwave heating profiles and temperature data for the susceptor samples prepared from the compositions of Examples 1-3. In Comparative Example 1, only the carbon-loaded binder was applied to the substrate. No coated polymeric particles were present. As shown in FIG. 2, the specimen of Comparative Example 1 exhibited a rapid temperature rise and runaway heating. In Examples 1-3, however, with the carbon-coated particles incorporated into the binder, the specimens were self-limiting and the temperatures reached a plateau.

TABLE 1
Carbon-coated particles

| | | | | Approximate |
|---|---|---|---|---|
| | | Average | Melting | Specimen |
| | | Equivalent | Point of | Plateau |
| | Particle | Spherical | Polymer | Temperature |
| Example | Core | Diameter | (° C.) | (° C.) |
| Example 1 | PET | 20-40 um | 260 | 300 |
| Example 2 | PP | 20-40 um | 180 | 200 |
| Example 3 | PE | 20-40 um | 140 | 180 |
| Comp. | None | N/A | N/A | Did not |
| Ex. 1 | | | | plateau |

### Examples 4-6

### Metal-Coated Polymeric Particles in Carbon-Filled Polymer Matrix

Nickel-coated polyester particles (P904) were purchased from Federal Technology Group, Advanced Ceramics MCP Division, Cleveland, Ohio 44101. The PET particles were characterized by an average equivalent spherical diameter of 30 micrometers. The PET particles were nickel-coated by a water-based electroless metal plating process. The nickel coating represented 80 wt % of the weight of the coated particle.

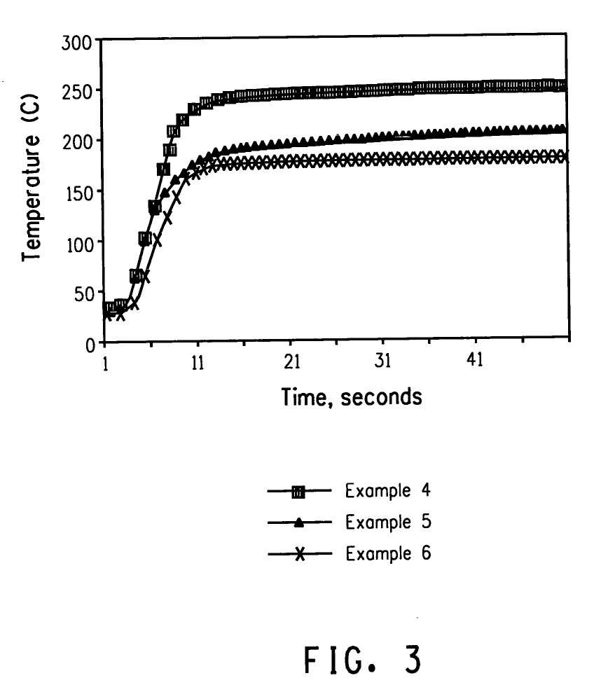

In the amounts shown in Table 2, the as-received nickel-coated particles were mixed with the carbon black soy ink, and with extra soy protein polymer binder as was employed in Examples 1˜3. The resulting ink paste was applied to the Thermount® papers of Examples 1˜3 using the method of Examples 1˜3. Table 2 shows each specimen's plateau temperature measured by the instrument and method described above, and FIG. 3 shows the microwave heating profiles of the susceptor samples prepared from the compositions of Examples 4-6.

TABLE 2
Metal Coated Particles

| | | | Weight | |
|---|---|---|---|---|
| | | Weight of | of Soy | Approximate |
| | | Nickel | Protein | Specimen |
| | Weight of | Coated PET | Polymer | Plateau |
| | Carbon Ink, | Particles | Binder | Temperature |
| Example | (Grams) | (Grams) | (Grams) | (° C.) |
| Example 4 | 10 | 6 | 16 | 240 |
| Example 5 | 10 | 3 | 16 | 205 |
| Example 6 | 10 | 3 | 24 | 180 |

### Examples 7 -12 and Comparative Example 2 Microwave Cooking Test

A circular specimen of a microwave susceptor was prepared from each of the compositions as used in Examples 1˜6 and Comparative Example 1, as described above. The susceptors used in Examples 7˜12 were prepared from the compositions of Examples 1˜6, respectively. The circular susceptor prepared from the composition of Comparative Examples 1 is labeled as such.

Each susceptor was placed on a new, never-used inverted paper plate (a microwave safe and grease resistant paper plate distributed by Supervalu Inc., Eden Prairie, Minn.) in a 1200 W microwave oven (Kenmore 1200). A frozen pizza (6.5 inch diameter Digiorno with Extra Cheese) was placed on the circular microwave susceptor with the susceptor ink side in contact with the paper plate and facing away from the pizza. Cooking was performed for 5 minutes at 100% power.

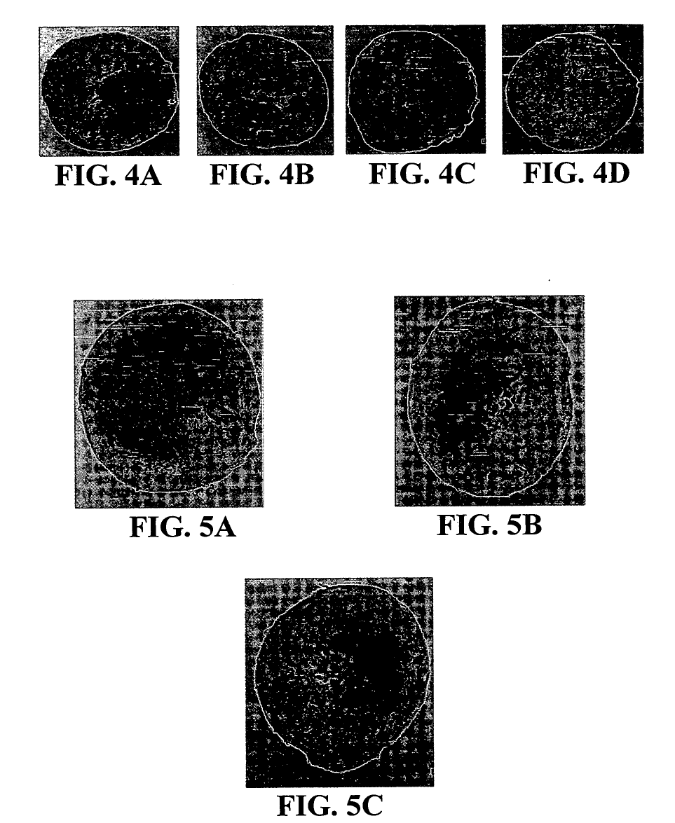

FIGS. 4a˜4d show the pizza crust browning results for the susceptors of Examples 7˜9 and Comparative Example 1. FIGS. 5a˜5c show the pizza crust browning results for the susceptors of Examples 10˜12. The susceptors used in Examples 7˜9, 11 and 12 provided crisping of the pizzas without excessive browning or burning. The performance of the susceptor used in Example 10, in providing a level of browning that might not be suitable for all tastes, was not dissimilar from the performance of Comparative Example 1, and the Example 10 susceptor might thus be best suited for a lower power oven.

Where a composition, article or method of this invention is stated or described as comprising, including, containing, having, being composed of or being constituted by certain components or features, it is to be understood, unless the statement or description explicitly provides to the contrary, that one or more components or features in addition to those explicitly stated or described may be present in the composition, article or method. In an alternative embodiment, however, the composition, article or method of this invention may be stated or described as consisting essentially of certain components or features, in which embodiment components or features that would materially alter the principle of operation or the distinguishing characteristics of the composition, article or method are not present therein. In a further alternative embodiment, the composition, article or method of this invention may be stated or described as consisting of certain components or features, in which embodiment components or features other than those stated or described are not present therein.

Where the indefinite article “a” or “an” is used with respect to a statement or description of the presence of a component or feature in a composition, article or method of this invention, it is to be understood, unless the statement or description explicitly provides to the contrary, that the use of such indefinite article does not limit the presence of the component or feature in the composition, article or method to one in number. The words “include”, “includes” and “including”, when used herein, are to be read and interpreted as if they were followed by the phrase “without limitation” if in fact that is not the case.

What is claimed is:

1. A composition comprising (a) a binder; and (b) dispersed within the binder, (i) a plurality of first particles that comprise a body material that is microwave-interactive; and (ii) a plurality of second particles that comprise (A) a body material that is not microwave-interactive, and (B) a coating formed from a coating material that is microwave-interactive, wherein the coating material is disposed upon, or embedded within, the surface of the body of the second particles.

2. The composition of claim 1 wherein the ratio of the size of the particles prepared from a body material that is not microwave-interactive to the size of the particles prepared from a body material that is microwave-interactive is in the range of about 1000/1 to about 10/1.

3. The composition of claim 1 wherein the particles that comprise a body material that is not microwave-interactive are micro-scale in size.

4. The composition of claim 3 wherein the particles that are micro-scale in size are characterized by an average equivalent spherical diameter of about 20 to about 40 micrometers.

5. The composition of claim 1 wherein the particles that comprise a body material that is microwave-interactive are nano-scale in size.

6. The composition of claim 3 wherein the particles that comprise a body material that is microwave-interactive are nano-scale in size.

7. The composition of claim 1 wherein the binder comprises a natural polymer.

8. The composition of claim 7 wherein the natural polymer comprises soy protein.

9. The composition of claim 1 wherein the body material that is not microwave-interactive is selected from one or more members of the group consisting of poly(ethylene terephthalate), polypropylene, polyethylene and derivatives of any of them.

10. The composition of claim 1 wherein the microwave-interactive coating material is particulate in nature.

11. The composition of claim 10 wherein the average equivalent spherical diameter of the particulate coating material is not greater than 10% of the average equivalent spherical diameter of the particle body itself.

12. The composition of claim 1 wherein the microwave-interactive coating material is selected from the group consisting of carbon black, graphite, copper, nickel, zinc, aluminum, carbon-coated iron, carbon-coated aluminum, and mixtures thereof.

13. The composition of claim 1 wherein the thickness of the coating is in the range of about 0.1 to about 1 micrometer.

14. The composition of claim 1 formulated as an ink that may be deposited on a surface.

15. The composition of claim 1 which is fabricated as a film.

16. The composition of claim 15 wherein the film is laminated to a substrate.

17. The composition of claim 16 wherein the substrate is a material that is not microwave-interactive.

18. The composition of claim 15 wherein the film is incorporated into a layered structure.

19. The composition of claim 1 which is deposited on a substrate.

20. The composition of claim 19 wherein the substrate is a material that is not microwave-interactive.

21. The composition of claim 1 which is fabricated as a microwave susceptor.

22. A microwave susceptor comprising a substrate that comprises a material that is permitted for use in conjunction with human food, wherein the composition of claim 1 is deposited on the substrate.

23. The microwave susceptor of claim 22 wherein the substrate comprises a layer in a layered structure.

24. The microwave susceptor of claim 23 wherein the layered structure protects human food from contamination.

25. The microwave susceptor of claim 22 which is enclosed in or contacted with a package that protects human food from contamination.

26. A microwave susceptor comprising a film fabricated from the composition of claim 1.

27. The microwave susceptor of claim 26 wherein the film is laminated to a substrate, or is incorporated into a layered structure.

28. The microwave susceptor of claim 27 wherein the layered structure protects human food from contamination.

29. A method of making a microwave susceptor comprising fabricating the susceptor from the composition of claim 1.

30. The method of claim 29 wherein the composition of claim 1 is fabricated as a film, or is deposited on a substrate.
